(19) United States
(12) Patent Application Publication
(10) Pub. No.: US 2005/0211114 A1
(43) Pub. Date: Sep. 29, 2005

(54) Nano-optical color embrossing

(76) Inventors: Juergen Fahrenbach, Aichelberg (DE); Stefan Fellenberg, Berlin (DE)

Correspondence Address: Jacob Eisenberg, Seerainstrasse 3a, Steckborn, CH-8047, CH

(21) Appl. No.: 11/124,236

(22) Filed: May 9, 2005

Related U.S. Application Data
(63) Continuation of application No. PCT/DE03/03806, filed on Nov. 16, 2003.

(30) Foreign Application Priority Data
Nov. 16, 2002 (DE) 102 53 648.1

(51) Int. Cl. B44B 5/02; B44C 1/24

(52) U.S. Cl. 101/32; 101/4; 101/28

(57) ABSTRACT

An apparatus for embossing a surface with a nano-optical color structure includes a monolithic material. The monolithic material is mounted to a carrier and has an active area facing away from the carrier and, in use, towards a surface to be embossed. The active area has a surface structure with at least one predetermined nano structure that causes in the surface to be embossed a structure that generates a predetermined color structure when exposed to visible light.

### CROSS REFERENCE TO RELATED APPLICATIONS

The present application is a continuation application of international application no. PCT/DE2003/003806, filed on Nov. 16, 2003, which designated the United States and was pending at the time of designation and the filing of the present application; and further claims priority to German patent application Ser. No. 10/253,648.1, filed Nov. 16, 2002; both of which are herewith incorporated by reference.

### BACKGROUND OF THE INVENTION

The invention relates to a method and an apparatus for manufacturing surface structures using interferences at certain wavelengths that produce pure colors, or through creation of so-called structure colors.

Color surface structures are known, for example, through the Australian One Ounce Silver Dollar. As shown in FIG. 7, the surface of the Australian silver dollar includes a color kangaroo. Color surfaces, such as those of the Australian silver dollar, are produced through applying layers of paint containing pigments, or similar layers. Such surfaces last very long under glass, but not when carried in a wallet on a daily basis. Hence, it is an objective of the present invention to avoid this disadvantage and to provide an inexpensive and reliable color system for surfaces, and further to provide a way to effectively prevent the possibility of forgery of products or coins.

### SUMMARY OF CERTAIN INVENTIVE ASPECTS

It is one objective of the invention to produce structure colors generating surfaces through embossing. The surfaces are produced through dies and rollers in the range of nanometers.

Accordingly, one aspect involves an apparatus for embossing a surface with a nano-optical color structure. A monolithic material is mounted to a carrier and has an active area facing away from the carrier and, in use, towards a surface to be embossed. The active area has a surface structure with at least one predetermined nano structure that causes in the surface to be embossed a structure that generates a predetermined color structure when exposed to visible light.

Another aspect involves a method of embossing a surface with a nano-optical color structure. An apparatus having a monolithic material with an active area is provided, wherein the active area has a predetermined surface structure with at least one nano structure. The active area of the apparatus is positioned in proximity of a surface to be embossed. The active area is pressed against the surface thereby impressing the at least one nano structure into the surface, wherein the nano structure causes in the surface a structure that generates a predetermined color structure when exposed to visible light.

A further aspect involves a method of manufacturing a die for embossing a surface with a nano-optical color structure. A monolithic material having grain boundaries that are smaller than wavelengths of visible light is provided. An active surface of the monolithic material is treated to create a surface structure with at least one predetermined nano structure. The nano structure causes in the surface to be embossed a structure that generates a predetermined color structure when exposed to visible light.

The invention uses the physical principle of interference of optical waves. Structure colors are due to interference phenomena and can be observed, for example, on certain butterflies and peacocks. Light is diffracted at a diffraction grating structure resulting in a color that may be different depending on the incidence of light. As described herein, structures that cause the colors on butterflies and peacocks are created through embossing.

A method that uses embossing is in particular applicable for coins and rust resistant sheet metals, jewelry, and parts used in the automotive industry. For example, it is possible to mark any genuine spare part, any coin or any sheet metal forgery-proof with such a color structure.

The apparatus and the method described herein provide for a variety of advantages with respect to conventional methods. No paint is applied to a surface and, accordingly, paint does not need to be dried. This means, products can be produced faster and with forgery-proof surfaces. In addition, an architecture with a single-die control is provided for manufacturing patterns in stainless steel sheet metals or the like.

### BRIEF DESCRIPTION OF THE SEVERAL VIEWS OF THE DRAWINGS

These and other aspects, advantages and novel features of the embodiments described herein will become apparent upon reading the following detailed description and upon reference to the accompanying drawings. In the drawings, same elements have the same reference numerals.

FIG. 1 is a schematic illustration of a section of a butterfly wing in three different magnifications;

FIG. 2 is a schematic illustration of one embodiment of a die for embossing;

FIG. 3 is a schematic illustration of a reflection grating;

FIG. 4 is a schematic illustration of one embodiment of a system for embossing;

FIG. 5 is a schematic illustration of an embossed surface;

FIG. 6 is a cross-sectional view of the embossed surface of FIG. 5;

FIG. 7 is a schematic illustration of the Australian One Ounce Silver Dollar;

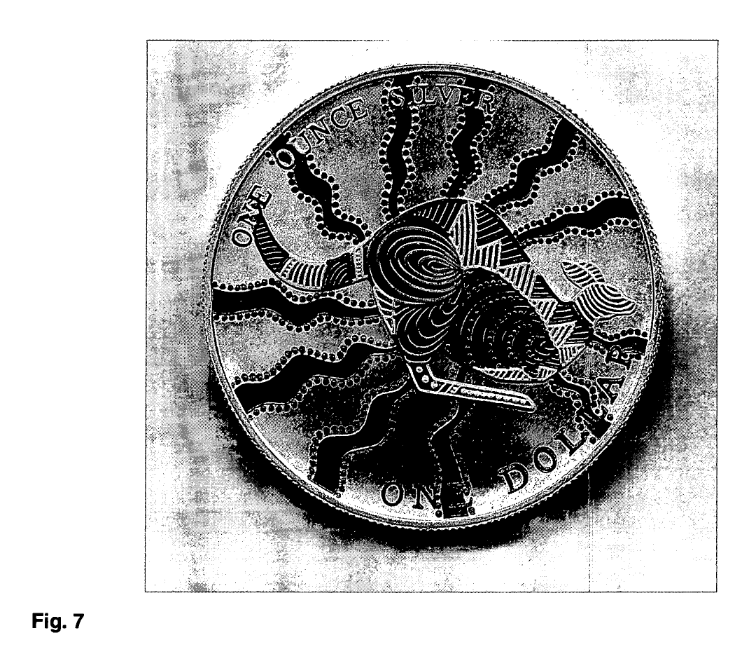

FIG. 8 illustrates the manufacture of a die using a cluster sputtering system; and

FIG. 9 is a schematic illustration of one embodiment of an apparatus for verifying an angle parameter.

### DETAILED DESCRIPTION OF CERTAIN INVENTIVE EMBODIMENTS

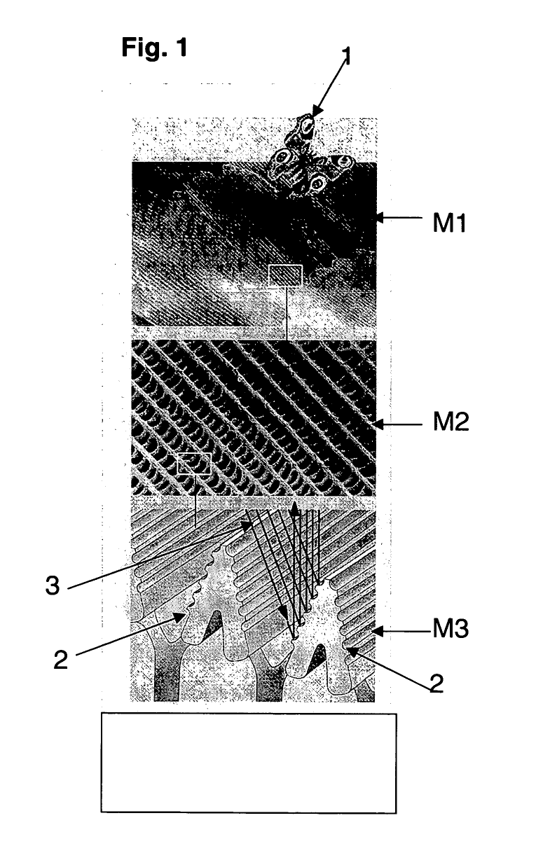

FIG. 1 is a schematic illustration of a section of a wing of a butterfly 1 in three different magnifications M1, M2, M3 in a scanning electron microscope. The magnification increases from top to bottom so that the wing's rip structure 2 is visible at the highest magnification M3 at the bottom of FIG. 1. This rip structure 2 functions as a step grating and generates the iridescent interference colors visible on the butterfly's wings. Light incident on the wing's rip structure 2 is indicated through arrows 3.

Visible light is in the wavelength range between about 400 nm (violet) and about 690 nm (red), with blue at about 486 nm, green at about 527 nm and yellow at about 589 nm. These wavelengths determine the geometric dimensions of the intended structure that generates a structure color, as exemplary shown in FIG. 1. In the bottom part of FIG. 1, at the magnification M3, an observer's eye registers that part of light, which is reflected on the rip structure 2, as a color. This means that the geometric dimension (e.g., distance of the rips) of the grating is responsible for the color effect. Light that is not reflected is absorbed below the grating structure and is not noticeable by the observer's eye. Hence, the step grating structure illustrated in FIG. 1 is responsible for the iridescent blaze of color because light with different wavelengths is reflected due to the spacing of the various lattices.

For the manufacture of punches and dies the diffraction effect is now, similar to the colors of the wings of a butterfly or a peacock's feather, imitated in form of an embossing structure, which creates the diffraction grating. As known in the art, a diffraction grating includes a large number of fine equidistant grooves. Light falling on such a grating is dispersed into a series of spectra on both sides of the incident beam, the angular dispersion being inversely proportional to the line spacing.

For example, a negative of the structure shown in FIG. 1 is reproduced on a die, as described below, which is then used to emboss a surface. The distance of the cross lattices determines the color. The die penetrates preferably about ¼of its width into the surface. The area of an inner grating (i.e., rips within each rip of the rip structure 2, as shown in lower part of FIG. 1) absorbs the remaining color and appears somewhat velvety, i.e., the grating matrix is shiny, and the inner part is rough. The desired color is thereby reflected, but the non-preferred color is absorbed.

The die has a nanometer structure (hereinafter referred to as nano structure) made through lathing, matrix erosion or laser ablation. An alternative method is the manufacture of a master die in pixel size, which is then used for eroding a working die. Mono-crystalline diamonds are advantageous because of their microstructure. The brilliance is then particularly advantageous.

In the wavelength range of visible light, for example, a metal surface is permanently formed through embossing, i.e., through cold forming, cold-warm forming or warm forming under protective gas, so that the corresponding color is created through interference.

Monolithic materials are preferably used for embossing because they do not have grain boundaries that are larger than the wavelength of the light of the respective color to be embossed. Exemplary monolithic materials are, among other examples, diamonds and monolithic grown quartzes. The hardness of a diamond, however, is an advantage for the nano-optical color embossing described herein.

Blue diamonds are electrical semiconductors and can be cloned from a master die through sink erosion methods using electrodes. The clone die is made as a master die with a negative structure. This allows producing several working dies. Monolithic semiconductor quartzes can be used as a clone electrode for making a working die.

Actuators containing quartzes are preferably used for the manufacture of the master electrodes. Such actuators are commercially available, for example, from Physik Instrumente (PI) GmbH & Co. KG, Germany. These actuators can be controlled in the nanometer range.

The described embossing method for producing color surfaces or for producing so-called structure colors is done without using color pigments, but through permanently forming selected surfaces.

The punch is made of monolithic crystals and in particular through a laser treatment that produces the surface of the monolithic crystal. In a so-called “egg” containing a methane atmosphere, diamond growth occurs on a metal cylinder through methane deposition, which creates a diamond sleeve on the cylinder. The monolithic diamond sleeve is laser treated to produce a chequered nano structure. The hard surface of the die or the roll containing the structure penetrates into the surface of the other material so that it is permanently deformed and the structure is embossed into it.

In one embodiment, mono-crystals are permanently deformed under protective gas above a re-crystallization temperature of the mono-crystals. The die or its movement is controlled so that the penetration depth does not destroy the embossing crystal. Through the arrangement of different dies, for example, each for a different color effect, multicolor prints can be produced, for example, as in a color matrix printer.

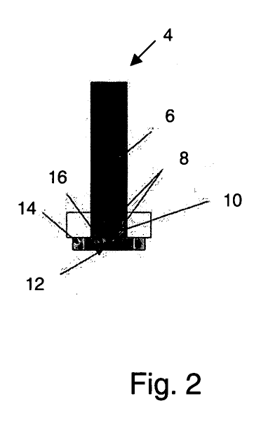

FIG. 2 is a schematic illustration of one embodiment of a die 4 for embossing, in particular for nano-optical color embossing. The die 4 has a carrier 6, an embossing diamond 16, and a heating 10 soldered to the carrier 6 and the diamond 16 at soldering surfaces 8. The diamond 16 has an active area 12 that includes the negative structure. Further, the die 4 includes a ring 14 that surrounds the embossing diamond 16. The heating 10 is for heating the diamond 16 and for warm forming the metal above the re-crystallization temperature of the metal.

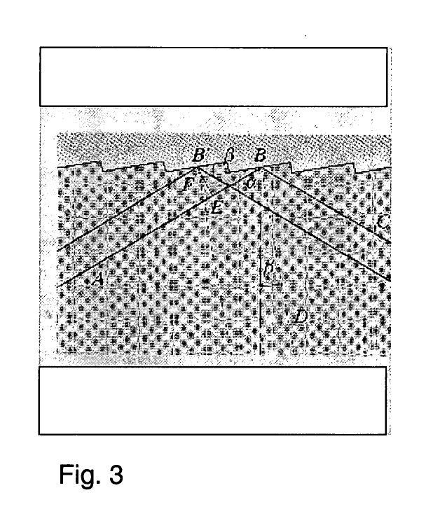

FIG. 3 is a schematic illustration of a reflection grating. As known in the art, a grating is generally a framework or latticework having an even arrangement of lines, groves, or any other long narrow objects with interstices between them, used to disperse light or other radiation by interference between wave trains from the interstices. The ability of a grating to separate wavelengths (chromatic resolution) is expressed as being equal to the number of lines in the grating. As illustrated in FIG. 3, the reflection grating has a lattice constant d, with d=B′B, which is determined prior to the embossing.

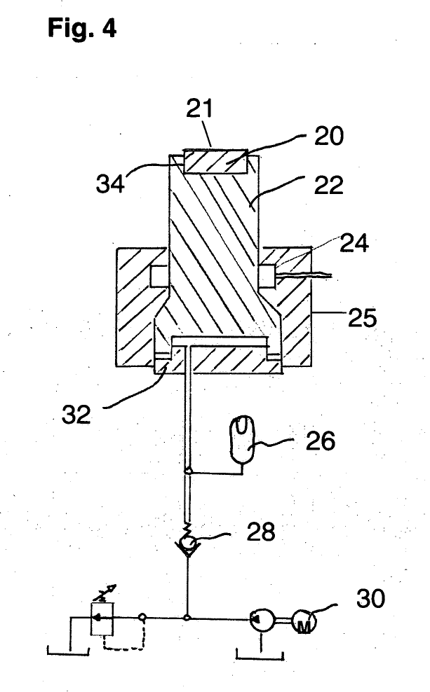

FIG. 4 is a schematic illustration of one embodiment of a system for embossing, wherein a die or an arrangement of dies is provided with an apparatus configured to maintain the pressing force constant. This apparatus or a force limitation protects the die from overload and destruction.

Pictures, for example, are created through arranging several embossing diamonds in a manner similar to a style known as Tiffany. The system may include a press for embossing, for example, a picture. In one embodiment, presses known from embossing coins may be used, for example, so-called C presses. In one embodiment, each die has a diamond.

The dies are used with elastic intermediate shafts to limit the pressing force. The system of FIG. 4 has an embossing area 21, a diamond 20 mounted to a solder support 34 of a diamond carrier 25, a seal 24, a die carrier 25, a reservoir 26, a check valve 28, a pump 30 and an oil cushion 32.

For deforming mono crystals in the nanometer range embossing is done at about 800° C. in the semi-warm range above the re-crystallization temperature and under protective gas. The crystal lattice thereby remains permanently in the desired form.

With certain metals, for example, gold or copper having their own base colors, the base color is, contrary to silver or stainless steels, compensated through a phase shift of the wavelength and the interference resulting from that.

The die is preheated to heat the surface of the material to be embossed so that the material is deformed above its re-crystallization temperature.

For producing the die a mono crystalline diamond is laser soldered with cobalt. Cobalt is a bonding agent for metal particles.

A phase shift of the interference lattice is adapted to the base material so that the desired color is created. The interference lattice is a length that denotes the size of the unit cell in a crystal lattice. With respect to the cubic crystal, this is the length of the side of the unit cell.

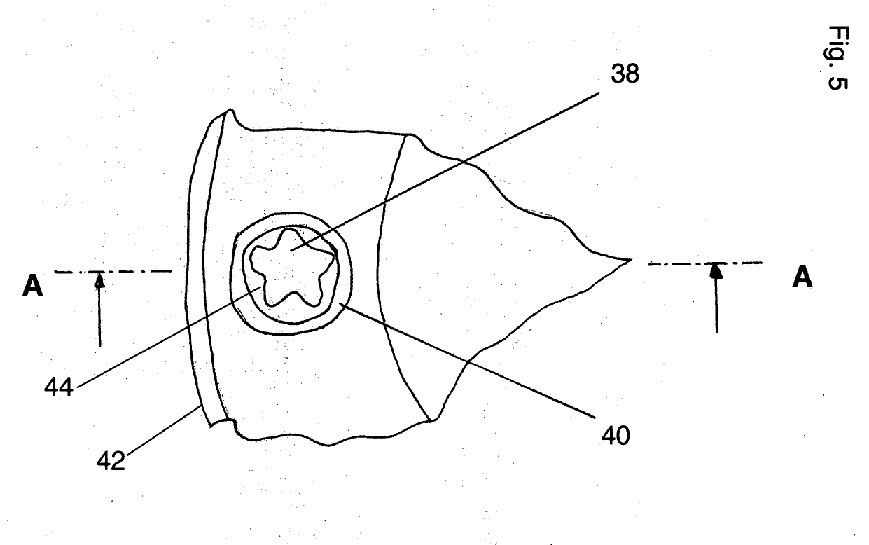

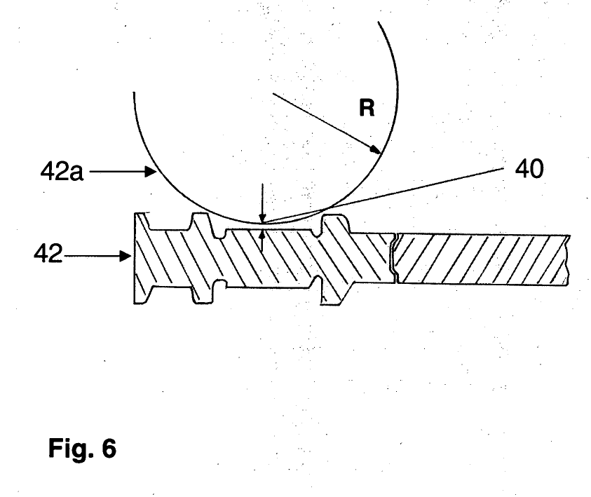

FIG. 5 is a schematic illustration of an embossed surface, and FIG. 6 is a cross-sectional view of the embossed surface of FIG. 5 along line A-A. Referring, for example, to a surface 42 of a Euro coin, a star 38, or several stars are embossed in a recess 44, which is surrounded by a protective shoulder 40, to provide for the forgery safety and to reduce scratching of the star 38. This is referred to as protective embossing. Preferably, the recess 44 is configured so that the smallest coin 42a of a currency, for example, the 1 Cent Euro coin, cannot enter the recess 44 because of the protective shoulder 40, as shown in FIGS. 5 and 6. The recess 44 is further used to center the die.

To produce the dies micro positioning tables, for example, available from Physik Instrumente, Germany, are used. These tables include piezo quartzes that are operable at a frequency of about 3000 Hz, and can therefore be adjusted rapidly. This results in reduced processing times.

The dies are electrostatically micro coated with nano particles of colloidal Teflon to provide for cleaning and lubrication. The final cleaning occurs in an ultrasound bath with water.

For producing the master structure a genuine butterfly wing or a peacock's feather are scanned, the scanned structure is enlarged by the penetration depths of the plastic deformation of the die material, and the material is then ablated through a laser or an electron beam. Preferably, the animals are only sedated and as such do not need to be killed. The ablation of the surface structure occurs through magnetic ablation with sanding micro particles in an interferent magnetic field. The frequency of the magnetic field determines the distance of the interferometer grating and, hence, the color of the generated wavelength.

The scanning of the wing may be done using a light source in the radio logic spectrum with a wavelength of about 2 nm, or X-ray photography (5000 film).

Further treatment occurs in a vacuum tube through an electron beam grating. Material is ablated due to the evaporation of material. The embossing plate is polished atomically.

The die is provided with a predetermined reference parameter that depends on the limit of plasticity. The parameter is for observing the color at a defined observation angle of, for example, 45 degrees with regard to the perpendicular of the crest in two planes, as shown in FIG. 3.

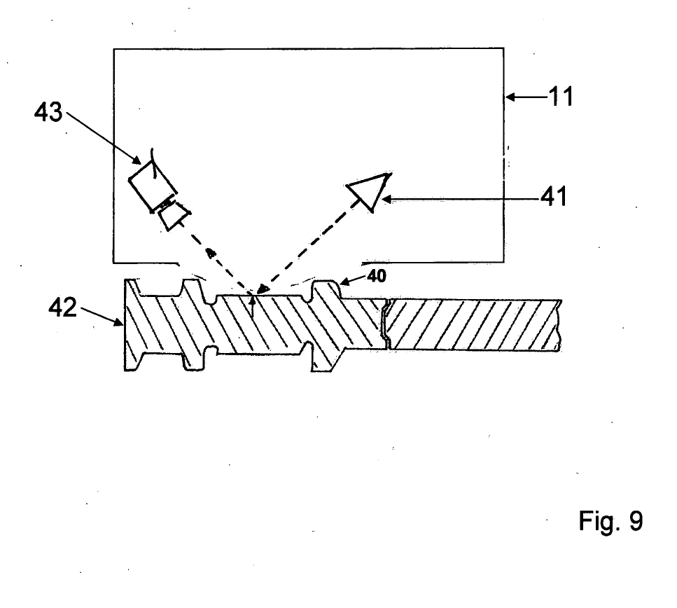

To create the multicolor embossing with such an angle parameter through several embossing steps makes the embossing process technological demanding and, hence, very forgery proof. In an advantageous embodiment, the angle parameter may be combined with embossing a hologram to improve the resistance against forgery. The angle parameter together with a corresponding test equipment 11 shown in FIG. 9 helps, for example, in a counting apparatus of a state central bank to verify if the coins are genuine using a spectral camera and angle coding.

With the interference Bragg condition, the step of an Echelette grating is met. As known in the art, Bragg's law defines the condition under which a crystal will reflect a beam of x-rays with the greatest amount of distinction or resolution and, at the same time, denoting the angle at which the reflection occurs. Further, an Echelette grating is a diffraction grating with lines and grooves formed so as to concentrate the radiation of a particular wavelength into one specified order. Purer color reflections are thereby created with the conditions of the Echelette grating being met. The mentioned method provides, if applied, for the coins' resistance against forgery.

An alternative embodiment uses perforated foils that may be applied to a coin. A die having a nano optic structure embosses the foils to produce the structure colors on the coin. Particular dies for closing and forming an embossed area create a protective shoulder to protect the structure from scratching.

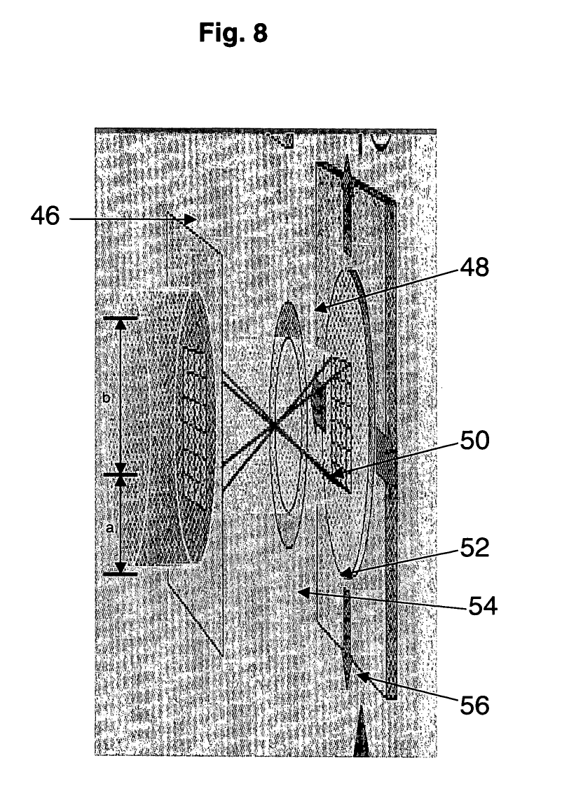

FIG. 8 illustrates the manufacture of a die using a cluster sputtering system. The die may be made of an electron-beam polished mono crystal, such as a diamond. If the die is made of metal, for example, plates, in particular made of austenitic sheet metals are rolled and then color embossed. The surface of the die is polished and treated through an electron or X ray drilling system. Prior to that, a CAD/CAM association determines parameters, which are illustrated or processed. In this manner, forgery of the Euro, in particular of higher values, is more difficult.

The surfaces of the diamonds are heated. Thereby, re-formations in the crystal structure above the re-crystallization temperature of the materials to be embossed are possible. The ruled lines 90+−5 are adjusted with respect to each other and treated through an electron beam.

The cross lattice is formed or treated using the Finite Element Method (FEM) during the re-formation so that the brilliance and purity are maintained. The whole color spectrum may be produced through multi color printing. The diamond is prepared with certain colors and cut for the mother die, the cut diamond is then mounted to the mother die and arranged in Tiffany style, in particular using laser soldering.

With one or multi-step embossing presses, the die is positioned image or angle synchronous through an optical recognition system via rotary driven dies. One or more dies are treated in a cluster sputtering system with a short wave X ray laser, as shown in FIG. 8. The one or more diamonds are made of SP 6 lattice. The diamonds are positioned under 45 and 90 degrees because of the lines of shearing stress. The embossing flux lines are therefore more precise.

The dies are manufactured through cluster sputter laser burning, i.e., optic or magnetic lenses divide the particularly short wave X ray laser into numerous parallel aligned single beams. This allows keeping the number of translations smaller. The multiple division of the beams results in a shorter burning time and, hence, reduced costs, see FIG. 8.

FIG. 9 is a schematic illustration of one embodiment of an apparatus 11 for verifying the angle parameter mentioned above. The surface 42 with its protective shoulder 40 are positioned under the apparatus 11. A light source 41 emits light that the embossed structure reflects. A camera 43 detects the reflected at a certain angle.

1. An apparatus for embossing a surface with a nano-optical color structure, comprising:
a carrier; and
a monolithic material mounted to the carrier, the monolithic material having an active area facing away from the carrier and, in use, towards a surface to be embossed, the active area comprising a surface structure with at least one predetermined nano structure, the nano structure causing in the surface to be embossed a structure that generates a predetermined color structure when exposed to visible light.

2. The apparatus of claim 1, wherein the monolithic material has grain boundaries that are smaller than wavelengths of visible light.

3. The apparatus of claim 1, wherein the monolithic material is a diamond.

4. The apparatus of claim 1, further comprising a heating coupled to the monolithic material to heat the monolithic material to a predetermined temperature.

5. The apparatus of claim 1, wherein the surface structure of the active area comprises a plurality of nano structures arranged as a Tiffany pattern.

6. The apparatus of claim 1, wherein the monolithic material is a metal.

7. A method of embossing a surface with a nano-optical color structure, comprising:
providing an apparatus having a monolithic material with an active area, the active area comprising a predetermined surface structure with at least one nano structure;
positioning the active area of the apparatus in proximity of a surface to be embossed; and
pressing the active area against the surface thereby impressing the at least one nano structure into the surface, the nano structure causing in the surface a structure that generates a predetermined color structure when exposed to visible light.

8. The method of claim 7, further comprising limiting a force that presses the active area against the surface to prevent damage to the surface.

9. The method of claim 7, further comprising heating the monolithic material.

10. A method of manufacturing a die for embossing a surface with a nano-optical color structure, comprising:
providing a monolithic material having grain boundaries that are smaller than wavelengths of visible light;
treating an active surface of the monolithic material to create surface structure with at least one predetermined nano structure, the nano structure causing in the surface to be embossed a structure that generates a predetermined color structure when exposed to visible light.

11. The method of claim 10, wherein the monolithic material is a diamond.

12. The method of claim 10, wherein treating the active surface includes using an X-ray laser to create the at least one nano structure.

13. The method of claim 10, wherein treating the active surface includes one of lathing, matrix erosion and laser ablation.
